(19) United States
(12) Patent Application Publication
(10) Pub. No.: US 2012/0032781 A1
(43) Pub. Date: Feb. 9, 2012

(54) REMOTE PERSONAL AUTHENTICATION SYSTEM AND METHOD USING BIOMETRICS

(75) Inventors: Dae-Sung MOON, Daejeon (KR); Jang-Hee YOO, Daejeon (KR); Byung-Jun KANG, Daejeon (KR); Yun-Su CHUNG, Daejeon (KR); Jeong-Nyeo KIM, Daejeon (KR)

(73) Assignee: Electronics and Telecommunications Research Institute, Daejeon-city (KR)

(21) Appl. No.: 13/198,226

(22) Filed: Aug. 4, 2011

(30) Foreign Application Priority Data
Aug. 9, 2010 (KR) 10-2010-0076353
Dec. 22, 2010 (KR) 10-2010-0132869

(51) Int. Cl. G06F 7/04

(52) U.S. Cl. 340/5.82

(57) ABSTRACT

Disclosed herein is a remote personal authentication system and method using biometrics. The remote personal authentication method using biometrics includes receiving a biometric information of a user remotely detected by a biometric information collection device; decrypting, in a hardware security module (HSM) of the user, the received biometric information and biometric information stored in the HSM; and performing personal authentication for the user by comparing the decrypted biometric information with each other in the HSM.

### CROSS REFERENCE TO RELATED APPLICATIONS

This application claims the benefit of Korean Patent Application Nos. 10-2010-0076353 and 10-2010-0132869, filed on Aug. 9, 2010 and Dec. 22, 2010, respectively, which are hereby incorporated by reference in their entirety into this application.

### BACKGROUND OF THE INVENTION

1. Technical Field

The present invention relates generally to a remote personal authentication system and method using biometrics and, more particularly, to a remote personal authentication system and method using biometrics, which is configured to prevent personal information from being infringed upon by storing biometric information in a hardware security module (HSM) and which is configured to protect the HSM from illegitimate use attributable to the loss of the HSM.

2. Description of the Related Art

Biometric systems utilize biometric technology that can identify individuals using information about fingerprints, faces, voices, irises, or the like. Biometric systems can replace marginal personal password systems in view of the fact that a shape or a voice is unique to each individual depending on his or her genes. Biometric systems are attracting attention as systems that can be used in places requiring high security because they come with no risk of loss and are highly accurate.

In general, the tasks of biometric systems are classified into authentication that is performed to authenticate the person himself or herself using biometric information and searching which is performed to detect the person himself or herself from a database (DB), in which a plurality of pieces of information has been stored, using biometric information.

When a biometric system is used for personal authentication, the biometric system authenticates the person himself or herself by comparing biometric information detected by the system with biometric information associated with a corresponding user ID. For this purpose, when a biometric system is used for personal authentication, it requires a user ID. That is, when a user ID is entered into an input device, such as a keypad, attached to a sensor for detecting a biometric information of a user, the biometric system authenticates the user by comparing biometric information corresponding to the entered user ID with detected biometric information. Here, fingerprint recognition and signature recognition are performed to authenticate a user based on contact with a sensor or the short-distance acquisition of biometric information, both authentication and searching can be performed. The reason for this is that a user ID can be entered through the keypad attached to the sensor.

When a biometric system is used for a search for a user, it remotely detects the biometric information of the user and searches information stored in a database for information about the corresponding user. For example, recently, research into a Closed Circuit Television (CCTV) camera-based remote facial recognition technology has been actively conducted. Acquired face information is transmitted from a CCTV camera to a server, and a face DB established in a server is searched for a similar face. CCTV camera-based remote facial recognition technology is used for various services such as searches for suspects in criminal investigations.

However, typical CCTV camera-based remote facial recognition technology cannot employ personal user IDs, such as Personal Identification Numbers (PINs), and thus the use thereof is limited to user searching. In the case of the above-described user search system, personal biometric information is stored in a central database, and therefore there is a possibility of privacy being infringing upon. Furthermore, the above system also has the problem of accurate user authentication being difficult because a smartcard or a Radio Frequency Identification (RFID) tag may be lent to another person or another person's tag may be stolen and then it may be used illegitimately.

However, when the biometric system is used for searching, a list of persons having biometric information similar to that of a user is retrieved from the database thereof and it is impossible to guarantee that a person in question always has the highest similarity in search results, with the result that it is impossible to provide services specific to the user. As a remote user authentication method using no biometric information, there is personal authentication and location tracking technology using a HSM (for example, an RFID tag, a smart card, a USB token, a mobile phone, or the like). However, the technology using a HSM has the problem of it being difficult to check whether a person in question is the legitimate owner of the HSM because the HSM may be lost or lent.

### SUMMARY OF THE INVENTION

Accordingly, the present invention has been made keeping in mind the above problems occurring in the prior art, and an object of the present invention is to provide a remote personal authentication system and method using biometrics, which is configured to perform personal authentication by comparing a biometric information of a user, remotely acquired using a biometric information acquisition device, with biometric information received from the HSM of the user.

In order to accomplish the above object, the present invention provides a remote personal authentication method using biometrics, including receiving a biometric information of a user remotely detected by a biometric information collection device; decrypting, in a hardware security module (HSM) of the user, the received biometric information and biometric information stored in the HSM; and performing personal authentication for the user by comparing the decrypted biometric information with each other in the HSM.

The remote personal authentication method using biometrics may further include transmitting the stored biometric information to the biometric information collection device; and receiving results of personal authentication generated by comparing the transmitted biometric information with the detected biometric information at the biometric information collection device.

The receiving includes receiving the biometric information encrypted by the biometric information collection device.

The receiving includes receiving the biometric information encrypted by the biometric information collection device.

The remote personal authentication method using biometrics may further include transmitting results of the personal authentication acquired by the performing. The remote personal authentication method using biometrics may further include outputting information about whether the detected biometric information has been successfully received and/or results of the personal authentication.

The stored biometric information and the detected biometric information comprise at least one of the user's face, iris, gait, shape of the ear, and voice.

Additionally, in order to accomplish the above object, the present invention provides a HSM, including a storage unit for storing a confidential information and a biometric information of a user; an electronic signature processing unit for creating and verifying the electronic signature of the user using the confidential information; a communication unit for receiving a biometric information of the user detected by a biometric information collection device at a remote location; and a control unit for performing personal authentication for the user by comparing the biometric information received from the communication unit with the stored biometric information.

The storage unit may store the biometric information including information about at least one of the user's face, iris, gait, shape of an ear, and voice.

The communication unit may transmit results of the personal authentication of the control unit to the biometric information collection device.

The communication unit may include one communication module of Wi-Fi, IrDA, RFID, ZigBee, and Bluetooth.

The HSM may further include an output unit for outputting information about whether the biometric information has been successfully received and results of the personal authentication.

The HSM may further include a security processing unit for encrypting the biometric information transmitted through the communication unit and decrypting the biometric information received from the communication unit.

Additionally, in order to accomplish the above object, the present invention provides a biometric information collection device, including a biometric information detection unit for remotely detecting a biometric information of a user; a communication unit for receiving an encrypted biometric information from a hardware security module (HSM) of the user; and a control unit for performing personal authentication for the user by comparing a decrypted biometric information of the encrypted biometric information with the detected biometric information.

The biometric information detection unit may include an image detecting module for detecting at least one of the user's face, iris, gait, shape of an ear, or shape of a hand and converting it into an image; and a voice detecting module for detecting the user's voice.

The biometric information detection unit may detect features of the biometric information of the user, and the communication unit may transmit the detected biometric information or the features of the detected biometric information to the HSM.

The control unit may control the communication unit so that the communication unit transmits results of the personal authentication for the user to the HSM.

The biometric information collection device may further include an output unit for outputting at least one of the detected biometric information, features of the detected biometric information, results of transmission and reception of information, and authentication results based on the detected biometric information and the decrypted biometric information.

The biometric information collection device may further include a security processing unit for encrypting the biometric information transmitted through the communication unit and decrypting the detected biometric information and the encrypted biometric information.

The control unit may transmit the biometric information detected by the biometric information detection unit to a server, and requests the server to search for user information.

### BRIEF DESCRIPTION OF THE DRAWINGS

The above and other objects, features and advantages of the present invention will be more clearly understood from the following detailed description taken in conjunction with the accompanying drawings, in which:

FIGS. 1 and 2 are diagrams illustrating the configurations of remote personal authentication systems using biometrics according to embodiments of the present invention;

FIG. 3 is a diagram illustrating the HSM of the remote personal authentication systems using biometrics according to an embodiment of the present invention;

FIG. 4 is a diagram illustrating the storage unit of FIG. 3;

FIG. 5 is a diagram illustrating the control unit of FIG. 3;

FIG. 6 is a diagram illustrating the biometric information collection device of the remote personal authentication system using biometrics according to an embodiment of the present invention;

FIG. 7 is a diagram illustrating the biometric information detection unit of FIG. 6;

FIG. 8 is a diagram illustrating the storage unit of FIG. 6;

FIG. 9 is a diagram illustrating the control unit of FIG. 6;

FIG. 10 is a flowchart illustrating a remote personal authentication method using biometrics according to an embodiment of the present invention; and

FIG. 11 is a flowchart illustrating a remote personal authentication method using biometrics according to another embodiment of the present invention.

### DESCRIPTION OF THE PREFERRED EMBODIMENTS

In order to describe the present invention in detail so that those having ordinary knowledge in the technical field to which the present invention pertains can readily practice the technical spirit of the present invention, preferred embodiments of the present invention will be described below with reference to the accompanying drawings. It should be noted that the same reference numerals are used throughout the different drawings to designate the same or similar components. Furthermore, in the following description, when it is determined that detailed descriptions of well-known functions related to the present invention and configurations thereof would make the gist of the present invention obscure, they will be omitted.

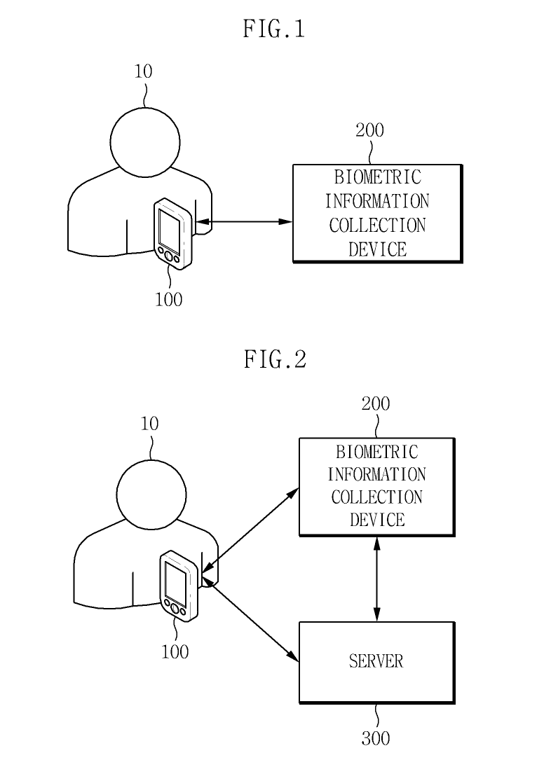

A remote personal authentication system using biometrics according to an embodiment of the present invention will be described in detail below with reference to the accompanying drawings. FIGS. 1 and 2 are diagrams illustrating the configurations of remote personal authentication systems using biometrics according to embodiments of the present invention.

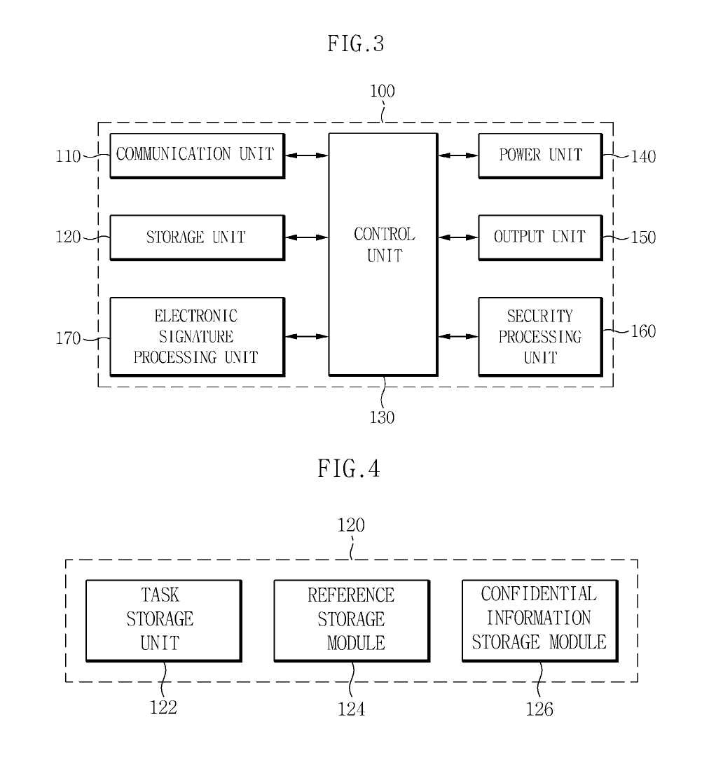

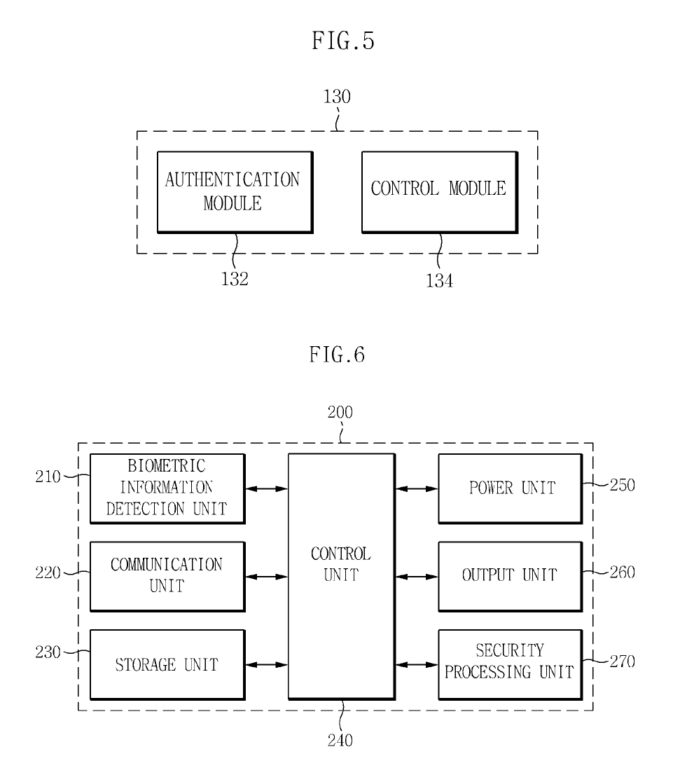

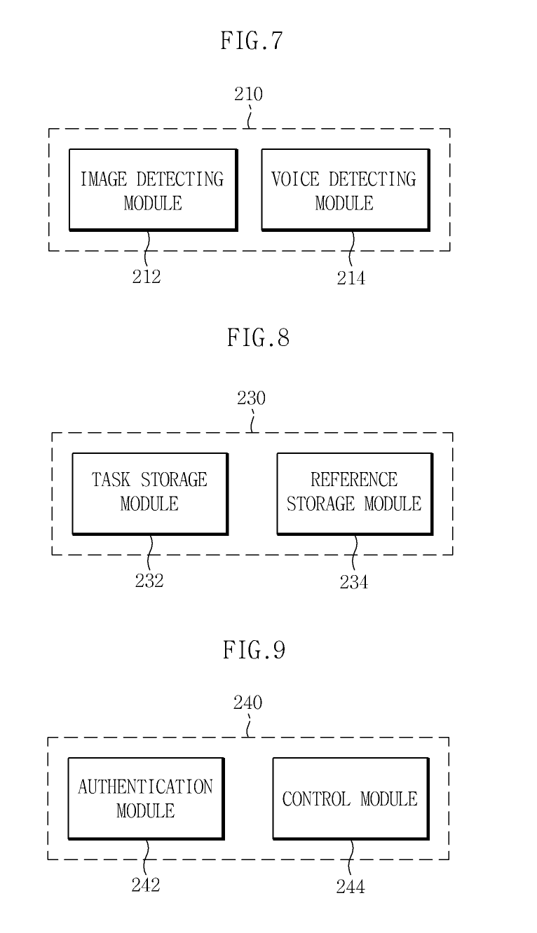

FIG. 3 is a diagram illustrating the HSM of the remote personal authentication systems using biometrics according to an embodiment of the present invention. FIG. 4 is a diagram illustrating the storage unit of FIG. 3. FIG. 5 is a diagram illustrating the control unit of FIG. 3. FIG. 6 is a diagram illustrating the biometric information collection device of the remote personal authentication system using biometrics according to an embodiment of the present invention. FIG. 7 is a diagram illustrating the biometric information detection unit of FIG. 6. FIG. 8 is a diagram illustrating the storage unit of FIG. 6. FIG. 9 is a diagram illustrating the control unit of FIG. 6.

As shown in FIG. 1, the remote personal authentication system using biometrics includes a HSM 100 for storing the biometric information of a user 10 and a biometric information collection device 200 for remotely collecting the biometric information of the user 10. As shown in FIG. 2, the remote personal authentication system using biometrics may further include a server 300 for conducting a search for the user 10 using biometric information and providing service management. Here, the HSM 100, the biometric information collection device 200, and the server 300 transmit and receive personal authentication-related information (that is, biometric information, authentication results, etc.) over a wireless local area network, such as a Wi-Fi, IrDA, RFID, ZigBee, or Bluetooth network. The biometric information collection device 200 and the server 300 may transmit and receive personal authentication-related information (that is, biometric information, authentication results, etc.) over a wired communication network.

The HSM 100 has wireless communication functionality, and stores the biometric information of the user 10. Here, the HSM 100 stores biometric information which can be remotely acquired, such as information about a face, the iris, a gait, the shape of an eye, a voice, or the like. Here, the HSM 100 may utilize one or more types of biometric information depending on the type of application service.

The HSM 100 performs personal authentication based on biometric information received from the biometric information collection device 200 and stored biometric information. That is, the HSM 100 authenticates whether the user 10 possessing the HSM 100 is a legitimate user 10 by comparing the biometric information received from the biometric information collection device 200 with the previously stored biometric information. The HSM 100 transmits authentication results to the biometric information collection device 200 or the server 300.

The HSM 100 includes an RFID tag, a smartcard, a USB token, or a mobile phone depending on the type of wireless communication method and the type of service provided by the server 300. The HSM 100 encrypts confidential information (for example, biometric information, a certificate, etc.) and then stores it in the device. Here, the HSM 100 encrypts and manages confidential information using a private key so that the confidential information can be prevented from being copied to the outside or reproduced in the outside.

For this purpose, as shown in FIG. 3, the HSM 100 includes a communication unit 110, a storage unit 120, a control unit 130, a power unit 140, an output unit 150, a security processing unit 160, and an electronic signature processing unit 170.

The communication unit 110 transmits the results of the authentication of the user 10 to the biometric information collection device 200 and the server 300. To this end, the communication unit 110 includes a wired/wireless communication module such as a Wi-Fi, IrDA, RFID, ZigBee, Bluetooth, or LAN communication module, so as to transmit authentication results to the biometric information collection device 200 and the server 300. Here, the communication unit 110 transmits and receives information to and from the biometric information collection device 200 over a wireless communication network. The communication unit 110 transmits and receives information to and from the server 300 over a wired or wireless communication network.

The storage unit 120 temporarily stores biometric information received from the biometric information collection device 200, and stores the encrypted biometric information of the user 10. The storage unit 120 stores confidential information which is used to process the user's electronic signature. For this purpose, as shown in FIG. 4, the storage unit 120 includes a task storage module 122 for temporarily storing biometric information received from the biometric information collection device 200 in order to use the biometric information when performing personal authentication, a reference storage module 124 for storing encrypted biometric information, and a confidential information storage module 126 for storing the confidential information of the user 10, such as an electronic signature creation key, which is used to create and verify an electronic signature. Here, the biometric information stored in the reference storage module 124 will be encrypted by a security processing unit 160, which will be described later.

The control unit 130 manages and controls the components of the biometric information collection device 200, and performs personal authentication by comparing the biometric information received from the biometric information collection device 200 with the biometric information stored in the storage unit 120. That is, the control unit 130 performs personal authentication by comparing the biometric information stored in the reference storage module 124 with the biometric information received from the biometric information collection device 200 in conjunction with the task storage module 122. Here, the control unit 130 performs personal authentication using the biometric information decrypted by the security processing unit 160 (which will be described later). To this end, as shown in FIG. 5, the control unit 130 includes an authentication module 132 for performing personal authentication using the biometric information received from the biometric information collection device 200 and the previously stored biometric information, and a control module 134 for managing and controlling components. Here, the biometric information collection device 200, which will be described later, may perform personal authentication using biometric information. In contrast, when the HSM 100 performs personal authentication, the biometric information of the user 10 previously stored in the HSM 100 is not divulged to the outside, thereby achieving the effect of protecting the privacy of the user 10.

The power unit 140 includes a battery therein, and supplies power to the HSM 100. It will be apparent that the power unit 140 may be supplied with external power through a wired connection and provide the power to the HSM 100.

The output unit 150 outputs information about whether biometric information has been successfully received, authentication results, etc.

The security processing unit 160 creates a private key that is used for the encryption and decryption of biometric information. The security processing unit 160 encrypts biometric information using the created private key, and stores it in the storage unit 120. The security processing unit 160 decrypts the biometric information stored in the storage unit 120 and the biometric information received through the communication unit 110 in response to a request from the control unit 130. The security processing unit 160 encrypts information that will be transmitted to the biometric information collection device 200 and the server 300.

The electronic signature processing unit 170 creates and verifies the user's electronic signature using the user's confidential information stored in the storage unit 120. Here, the electronic signature processing unit 170 prevents the confidential information (that is, the electronic signature creation key, or the like) from being copied to the outside of the HSM or reproduced in the outside of the HSM. For example, the electronic signature processing unit 170 creates and verifies an electronic signature, which is used for bidding and/or banking, using confidential information such as the user's personal certificate.

The biometric information collection device 200 includes a device capable of collecting images and voices, and remotely collects the biometric information of the user 10. Here, the biometric information collection device 200 may include an image detecting device for detecting image information to collect biometric information, such as a CCTV camera, and a voice detecting device for detecting voice information, such as a microphone.

The biometric information collection device 200 transmits the collected biometric information to the HSM 100 possessed by the user 10. That is, the biometric information collection device 200 collects the biometric information (that is, information about a face, an iris, a gait, the shape of an ear, a voice, or the like) of the user 10 at a remote location using a camera, a microphone, etc. The biometric information collection device 200 performs preprocessing on the collected biometric information, and transmits the features of the biometric information to the HSM 100 of the corresponding user 10. It will be apparent that the biometric information collection device 200 may transmit original biometric information on which preprocessing has not been performed to the HSM 100 of the user 10.

The biometric information collection device 200 may perform personal authentication by comparing the collected biometric information with the biometric information of the HSM 100. That is, the biometric information collection device 200 receives encrypted biometric information from the HSM 100. The biometric information collection device 200 decrypts the biometric information, and then performs personal authentication for the user by comparing the encrypted biometric information with collected biometric information. The biometric information collection device 200 transmits personal authentication results to the HSM 100 and the server 300.

The biometric information collection device 200 may transmit collected biometric information to the server 300 and then request a search using the biometric information of the corresponding user 10. For example, the biometric information collection device 200 transmits the face image of the user 10 collected remotely to the server 300 and then requests a search for a similar (or identical) face image.

For this purpose, as shown in FIG. 3, the biometric information collection device 200 includes a biometric information detection unit 210, a communication unit 220, a storage unit 230, a control unit 240, a power unit 250, an output unit 260, and a security processing unit 270.

The biometric information detection unit 210 remotely collects the biometric information of the user 10. Here, as shown in FIG. 7, the biometric information detection unit 210 includes an image detecting module for detecting an image of a face, an iris, a gait, the shape of an ear or the like in order to collect biometric information and a voice detecting module for detecting a voice.

The communication unit 220 transmits the biometric information detected by the biometric information detection unit 210 to the HSM 100 and the server 300. The communication unit 220 may receive encrypted biometric information from the HSM 100. The communication unit 220 includes a wired/wireless communication module, such as a Wi-Fi, IrDA, RFID, ZigBee, Bluetooth, or LAN communication module, in order to transmit and receive biometric information. Here, the communication unit 220 transmits and receives information through the HSM 100 and the wireless communication network. The communication unit 220 transmits and receives information to and from the server 300 over a wired/wireless communication network.

The storage unit 230 temporarily stores biometric information acquired upon the preprocessing of biometric information, and stores detected biometric information and other information. Here, as shown in FIG. 8, the storage unit 230 includes a task storage module 232 for extracting biometric features from acquired biometric information and a reference storage module 234 for storing biometric information and other information.

The control unit 240 controls the communication unit 220 and the security processing unit 270 so that they encrypts and transmits the biometric information of the user detected by the biometric information detection unit 210. Here, the control unit 240 may control them so that they extract only the features of biometric information and transmit them to the HSM 100. That is, the control unit 240 detects the features of biometric information by performing preprocessing on biometric information to be transmitted to the HSM 100 or the server 300 in conjunction with the storage unit 230 (that is, the task storage module 232). The control unit 240 performs control so that the detected features of the biometric information is encrypted and then transmitted to the HSM 100.

The control unit 240 manages and controls the components of the biometric information collection device 200. Here, when the biometric information collection device 200 performs personal authentication, as shown in FIG. 9, the control unit 240 includes an authentication module 242 for performing personal authentication using biometric information received from the HSM 100 and biometric information detected by the biometric information detection unit 210 and a control module 244 for managing and controlling the components. Here, the authentication module 242 performs personal authentication by comparing the biometric information received from the HSM 100 with the collected biometric information. That is, the authentication module 242 performs personal authentication using biometric information decrypted by the security processing unit 270 (which will be described later).

The power unit 250 includes a battery therein, and supplies power to the biometric information collection device 200. It will be apparent that the power unit 250 may be supplied with external power through a wired connection and provide the power to the biometric information collection device 200.

The output unit 260 outputs the biometric information of the user 10, the features of the biometric information, the results of the transmission and reception of information, and authentication results using biometric information.

The security processing unit 270 creates a private key that is used to decrypt biometric information. The security processing unit 270 decrypts biometric information received from the HSM 100 using the created private key. The security processing unit 270 encrypts information to be transmitted to the HSM 100 and the server 300 using a private key.

The server 300 detects information corresponding to the received biometric information in response to a request for a search from the biometric information collection device 200. That is, the server 300 has stored biometric information about a plurality of users 10. The server 300 detects information associated with biometric information similar to the biometric information received from the biometric information collection device 200. Here, the server 300 detects user information or service information. That is, the server 300 detects user information or service information corresponding to the received biometric information. The server 300 provides set service to the corresponding user 10 using the detected service information.

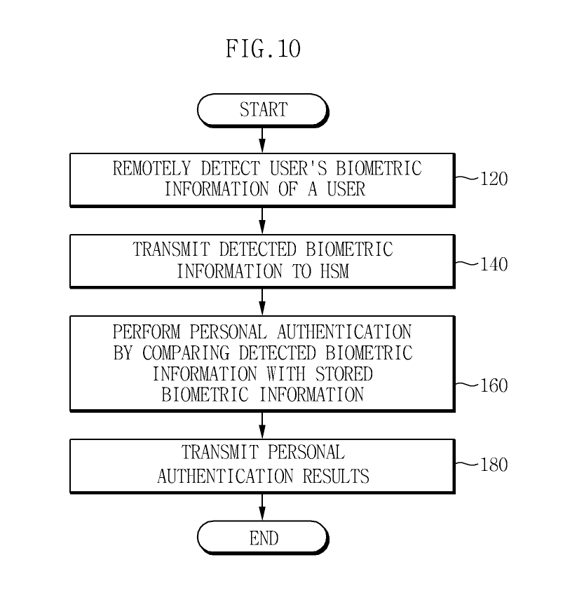

A remote personal authentication method using biometrics according to an embodiment of the present invention will be described below with reference to the accompanying drawings. FIG. 10 is a flowchart illustrating the remote personal authentication method using biometrics according to the embodiment of the present invention.

The biometric information collection device 200 remotely detects and collects the biometric information of the user 10 at step S120. Here, the biometric information collection device 200 includes an image detecting device, such as a CCTV camera, and collects information about a face, an iris, a gait, the shape of an ear, or the like as the biometric information of the user 10. The biometric information collection device 200 may include a microphone and collect the voice of the user 10 as biometric information.

The biometric information collection device 200 transmits the collected biometric information to the HSM 100 of the user 10 at step S140. Here, the biometric information collection device 200 performs preprocessing on collected biometric information, and then transmits the features of the biometric information to the HSM 100 of the corresponding user 10. It will be apparent that the biometric information collection device 200 may transmit biometric information on which preprocessing has not been performed to the HSM 100 of the user 10. Here, the biometric information collection device 200 encrypts the collected biometric information, and transmits it to the HSM 100.

The HSM 100 performs personal authentication by comparing the previously stored biometric information with the biometric information received from the biometric information collection device 200 at step S160. That is, the HSM 100 authenticates whether the user 10 possessing the HSM 100 is a legitimate user 10 by comparing the biometric information received from the biometric information collection device 200 with the previously stored biometric information.

The HSM 100 transmits personal authentication results to the biometric information collection device 200 at step S180. Here, the HSM 100 may transmit personal authentication results to the server 300.

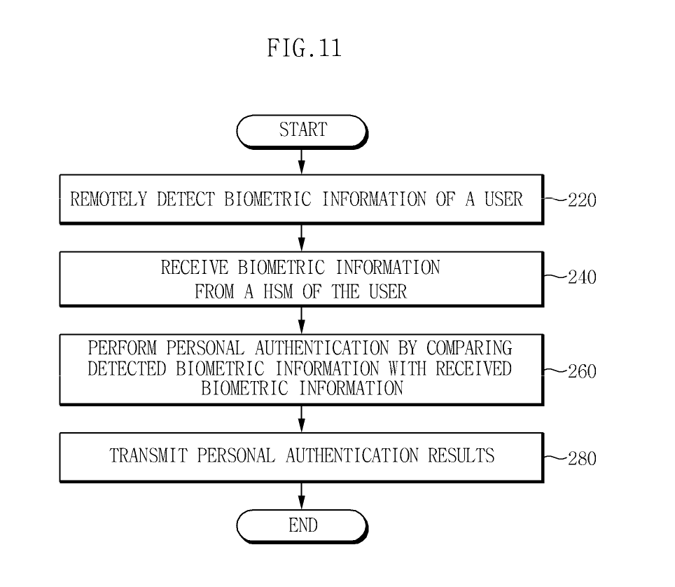

A remote personal authentication method using biometrics according to another embodiment of the present invention will be described below with reference to the accompanying drawings. FIG. 11 is a flowchart illustrating the remote personal authentication method using biometrics according to the embodiment of the present invention.

The biometric information collection device 200 remotely detects and collects the biometric information of the user 10 at step S220. Here, the biometric information collection device 200 includes an image detecting device such as a CCTV camera, and collects information about a face, the iris, a gait, the shape of the ear, or the like as the biometric information of the user 10. The biometric information collection device 200 may includes a microphone, and collect the voice of the user 10 as biometric information.

The biometric information collection device 200 receives biometric information from the HSM 100 of the user 10 in order to perform personal authentication at step S240. Here, the biometric information collection device 200 requests the transmission of the biometric information from the HSM 100 of the user 10 having collected the biometric information. In response to the request, the HSM 100 transmits previously stored biometric information to the biometric information collection device 200. Here, the HSM 100 encrypts and then transmits biometric information.

The biometric information collection device 200 performs personal authentication by comparing the collected biometric information with the biometric information received from the HSM 100 at step S260. That is, the biometric information collection device 200 authenticates whether the user 10 possessing the HSM 100 is a legitimate user 10.

The biometric information collection device 200 transmits personal authentication results to the biometric information collection device 200 at step S280. Here, the biometric information collection device 200 may transmit personal authentication results to the server 300.

As described above, the remote personal authentication system and method using biometrics is configured to perform personal authentication by comparing the biometric information of the user 10, acquired by the biometric information acquisition device, with biometric information received from the HSM 100 of the user 10, thereby providing the advantage of performing privacy-enhanced personal authentication by means of the remote personal authentication system using the portable HSM 100 in which biometric information has been stored.

Furthermore, the remote personal authentication system and method using biometrics is configured to enable biometric information to be stored in the portable HSM 100 and the portable HSM 100 to be possessed by an individual, thereby providing the advantage of enabling accurate personal authentication as well as a search for the user 10 to be performed.

Furthermore, the remote personal authentication system and method using biometrics is configured to enable accurate personal authentication to be performed, thereby providing the advantage of providing various application services customized for each individual.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A remote personal authentication method using biometrics, comprising:
receiving a biometric information of a user remotely detected by a biometric information collection device;
decrypting, in a hardware security module (HSM) of the user, the received biometric information and biometric information stored in the HSM; and
performing personal authentication for the user by comparing the decrypted biometric information with each other in the HSM.

2. The remote personal authentication method using biometrics as set forth in claim 1, further comprising:
transmitting the stored biometric information to the biometric information collection device; and
receiving results of personal authentication generated by comparing the transmitted biometric information with the detected biometric information at the biometric information collection device.

3. The remote personal authentication method using biometrics as set forth in claim 1, wherein the receiving includes receiving the biometric information encrypted by the biometric information collection device.

4. The remote personal authentication method using biometrics as set forth in claim 1, wherein the receiving includes receiving features of the biometric information detected by the biometric information collection device.

5. The remote personal authentication method using biometrics as set forth in claim 1, further comprising transmitting results of the personal authentication acquired by the performing.

6. The remote personal authentication method using biometrics as set forth in claim 1, further comprising outputting information about whether the detected biometric information has been successfully received and/or results of the personal authentication.

7. The remote personal authentication method using biometrics as set forth in claim 1, wherein the stored biometric information and the detected biometric information comprises at least one of the user's face, iris, gait, shape of the ear, and voice.

8. A hardware security module (HSM), comprising:
a storage unit for storing a confidential information and a biometric information of a user;
an electronic signature processing unit for creating and verifying the electronic signature of the user using the confidential information;
a communication unit for receiving a biometric information of the user detected by a biometric information collection device at a remote location; and
a control unit for performing personal authentication for the user by comparing the biometric information received from the communication unit with the stored biometric information.

9. The HSM as set forth in claim 8, wherein the storage unit stores the biometric information including information about at least one of the user's face, iris, gait, shape of an ear, and voice.

10. The HSM as set forth in claim 8, wherein the communication unit transmits results of the personal authentication of the control unit to the biometric information collection device.

11. The HSM as set forth in claim 8, wherein the communication unit comprises one communication module of Wi-Fi, IrDA, RFID, ZigBee, and Bluetooth.

12. The HSM as set forth in claim 8, further comprising an output unit for outputting information about whether the biometric information has been successfully received and results of the personal authentication.

13. The HSM as set forth in claim 8, further comprising a security processing unit for encrypting the biometric information transmitted through the communication unit and decrypting the biometric information received from the communication unit.

14. A biometric information collection device, comprising:
a biometric information detection unit for remotely collecting a biometric information of a user;
a communication unit for receiving an encrypted biometric information from a hardware security module (HSM) of the user; and
a control unit for performing personal authentication for the user by comparing a decrypted biometric information of the encrypted biometric information with the collected biometric information.

15. The biometric information collection device as set forth in claim 14, wherein the biometric information detection unit comprises:
an image detecting module for detecting at least one of the user's face, iris, gait, shape of an ear, or shape of a hand and converting it into an image; and
a voice detecting module for detecting the user's voice.

16. The biometric information collection device as set forth in claim 14, wherein:
the biometric information detection unit detects features of the collected biometric information, and
the communication unit transmits the collected biometric information or the features of the collected biometric information to the HSM.

17. The biometric information collection device as set forth in claim 14, wherein the control unit controls the communication unit so that the communication unit transmits results of the personal authentication for the user to the HSM.

18. The biometric information collection device as set forth in claim 14, further comprising an output unit for outputting at least one of the collected biometric information, features of the collected biometric information, results of transmission and reception of information, and authentication results based on the collected biometric information and the decrypted biometric information.

19. The biometric information collection device as set forth in claim 14, further comprising a security processing unit for encrypting the biometric information transmitted through the communication unit and decrypting the detected biometric information and the encrypted biometric information.

20. The biometric information collection device as set forth in claim 14, wherein the control unit transmits the biometric information detected by the biometric information detection unit to a server, and requests the server to search for user information.
